(19) United States
(12) Patent Application Publication
(10) Pub. No.: US 2013/0254244 A1
(43) Pub. Date: Sep. 26, 2013

(54) METHOD AND RELATED APPARATUS FOR GENERATING ONLINE AND PRINTING ON-DEMAND COMPILATION OF WORKS WITH TYPE DESIGNATION FEATURES

(71) Applicants: David ASAO, Irvine, CA (US); Daniel BARBER, Tustin, CA (US); Philip WU, Seal Beach, CA (US); Toshiro FUJIMORI, Laguna Beach, CA (US)

(72) Inventors: David ASAO, Irvine, CA (US); Daniel BARBER, Tustin, CA (US); Philip WU, Seal Beach, CA (US); Toshiro FUJIMORI, Laguna Beach, CA (US)

(73) Assignee: KONICA MINOLTA LABORATORY U.S.A., INC., San Mateo, CA (US)

(21) Appl. No.: 13/426,586

(22) Filed: Mar. 21, 2012

(51) Int. Cl. G06F 17/30

(52) U.S. Cl. 707/821; 707/E17.01

(57) ABSTRACT

A method for managing files for producing a compilation of works. The method includes the steps of obtaining a file of a work to be compiled in the compilation of works, specifying a type designation to the file or a portion thereof, and rendering special treatment of the file or the portion thereof according to the type designated to the file or the portion thereof when producing the compilation of works.

### BACKGROUND OF THE INVENTION

1. Field of the Invention

This invention generally relates to a method and related apparatus for generating online and printing on-demand compilation of works, and in particular, it relates to managing contents and assembling articles into booklets with type designation features.

2. Description of Related Art

The rapid development of new printing and telecommunication technologies has made it possible to generate and provide customized compilation of works in printed or other electronic forms on a print-on-demand (POD) basis, which generally refers to production of commercial-quality finished products in printed or electronic forms such as books and compilation booklets on a relatively small scale, typically by a professional print shop, at the request of customers.

One example of generating and producing compilations of works may be that in many educational institutions, a teacher or professor often needs to assemble a group of works and compile them into a volume of course materials. Another example may be that in a business entity or an organization, an instructor or trainer needs to assemble a group of works and compile them into a booklet of training materials. Such works may include previously published papers or articles, images and graphics etc. which may be available in hard copies traditionally but now increasingly in electronic (digital) formats, such as in the portable document (PDF) format.

These works may include PDF files in the teacher or instructor's own collection, e.g., stored in his or her own computer storage device such as a hard disc drive, or in a file folder assigned to him or her on a server of the institution or organization. These works may also include PDF files in other third parties' collections, e.g., stored in the third parties' servers and may be accessed via a computer network such as the Internet by using uniform resource locator (URL) links.

Once the teacher or instructor selects the PDF files, they can be assembled together to generate a compilation of works. After a compilation of works is generated into a volume or booklet of articles, students or organization members may purchase the volume or booklet by placing POD orders with a print shop that can print and deliver the volumes or booklets to the students or members.

In a volume or booklet of articles, different articles may require different treatment when the volume or booklet is printed in hard copies or otherwise delivered in electronic files. For example, some articles may be paginated while some others are not, or some pages may contain multimedia contents that cannot be printed out but may be included in an electronic file. There is a need to provide a more efficient and cost-effective method and related apparatus for online generation and purchase of compilations of works on a POD basis with the features for designating various types to articles and/or pages in a compilation of works so that the type-designated articles and/or pages can be handled accordingly.

### SUMMARY

The present invention is directed to a method and related apparatus for generating and printing compilations of works, which provides a more efficient and economical online platform for easily managing contents and assembling articles into booklets that can be readily ordered and printed on-demand, with type designation features to handle different types of articles and/or pages in a compilation of works.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method for managing files for producing a compilation of works which comprises the steps of: obtaining a file of a work to be compiled in the compilation of works; specifying at least one type designation to the file or a portion thereof; and rendering special treatment of the file or the portion thereof according to the at least one type designated to the file or the portion thereof when producing the compilation of works.

In another aspect, one exemplary embodiment of the present invention further provides a computer program product that causes a data processing apparatus to perform the above methods. The computer program product includes a computer usable non-transitory medium (e.g. memory or storage device) having a computer readable program code embedded therein for controlling a data processing apparatus, the computer readable program code configured to cause the data processing apparatus to execute the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates an exemplary online environment in which embodiments of the present invention may be implemented.

FIG. 2 schematically illustrates an exemplary computer program architecture in which embodiments of the present invention may be implemented.

FIG. 3 schematically illustrates an exemplary process for online management of contents and generation of booklets as parts of a computer-implemented method for generating and printing compilations of works in accordance with an embodiment of the present invention.

FIGS. 4-8 illustrate screen shots from executing various steps of the exemplary process for online management of contents as shown in FIG. 3.

### DETAILED DESCRIPTION OF PREFERRED EMBODIMENTS

Embodiments of the present invention provide a more efficient and cost-effective method and related apparatus for online management, generation and purchase of compilations of works on a print-on-demand (POD) basis.

As an example of practical scenarios of the need for managing, generating and printing compilations of works, a teacher or professor in an educational institution may need to assemble educational materials for the students to order and purchase. As another example of practical scenarios of such need, an instructor or trainer of a business entity or organization may need to assemble training materials for the members to order and purchase.

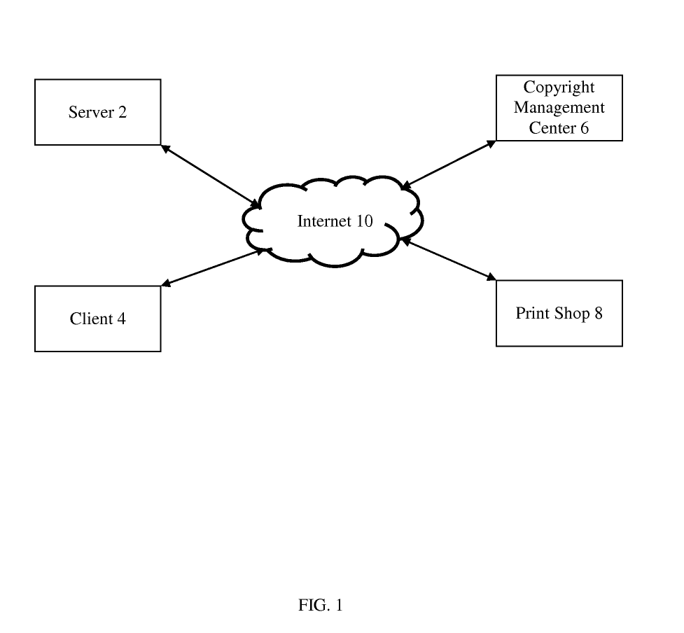

Referring to FIG. 1, there is schematically illustrated an exemplary online environment in which embodiments of the present invention may be implemented. The exemplary online environment includes a server 2, a client computer 4, one or more copyright management center servers 6, and a print shop server 8, connected via one or more computer network 10 such as the Internet or other communication links. A client (such as a teacher or a trainer, or a student or a member of an organization) uses the client computer 4 to interact with the server 2. The server 2 executes a computer program stored in a memory to perform processes according to the embodiments of the present invention. The copyright management center servers 6 stores digital contents and associated copyright data or license information that may be obtained for use by the clients. The print shop may be a professional print shop equipped with printers and various other image reproduction machines for producing printed products such as books, booklets, etc. The print shop server 8 manages the print jobs submitted to the print shop by the clients or customers.

The server 2 generally provides an integrated service that allows a client to search and acquire contents from content sources, to compile them into an electronic file and submit the compiled file to a POD service to produce a printed product, and to order and purchase the printed product of the compiled works. The clients may access the server 2 from their own computers 4 via the network 10 once they establish their user accounts on the server 2. The server 2 may interact with the copyright management center server 6 for searching and obtaining contents of the works to be compiled. The server 2 may also interact with the print shop server 8 for printing and delivering the compiled works in hard copy or electronic forms.

In this application, the term “copyright management center” generally refers to a place or service that facilitates the management and distribution of copyrighted materials and the obtaining and transferring of payment to copyright holders. Typically, a copyright management center facilitates legitimate access to copyrighted content by providing a copyright registry, where users can locate copyright information about a work, by also providing a copyright marketplace exchange, where users can buy and sell copyrights, and by further providing a copyright clearance service that can connect with third party distribution platforms. Examples of such copyright management centers may include digital repository of published work maintained by some publishers or digital libraries maintained by various organizations. Another example of copyright management center is the Copyright Clearance Center.

Therefore, “copyright management center 6” of the online environment shown in FIG. 1 may include any types of sources of digital contents and their copyright data and license information. More generally, “copyright management center 6” of the online environment shown in FIG. 1 may also include any third party content sources such as databases or depositories where hard or electronic copies of articles, publications or other contents and works may be stored or otherwise kept.

The physical locations or the commercial relationship among the various components of the online environment shown in FIG. 1 are not important. For example, the server 2 may be operated by the copyright management center, or the print shop, or a separate institution, organization or commercial establishment.

Also in this application the term “client” generally refers to a customer or anyone who uses the method or related apparatus provided by the embodiments of the present invention. For example it may refer to a teacher or student in an educational institute, or an instructor or a member in an organization. Specifically for the process described in this application, “client” may refer to “booklet compiler” and “booklet reader”, where “booklet compiler” (or “compiler”) refers to anyone who manages the contents or articles, and generates compilation of works from the contents or articles, and “booklet reader” (or “reader”) refers to anyone who orders the printing or purchases the finished product of the compilation of works that have already been generated. For example, a compiler may be a teacher in an educational institute or an instructor of an organization, whereas a reader may be a student in the educational institute or a member of the organization.

Both the compilers and the readers may have access accounts at the server 2 and share some common rights or features on the server 2, but some of their other rights may be different. For example, a compiler may have right to generate a booklet from compilation of works, whereas a reader may not have such right but may have right to order prints of the booklet. These details will become more apparent and clear in the description below.

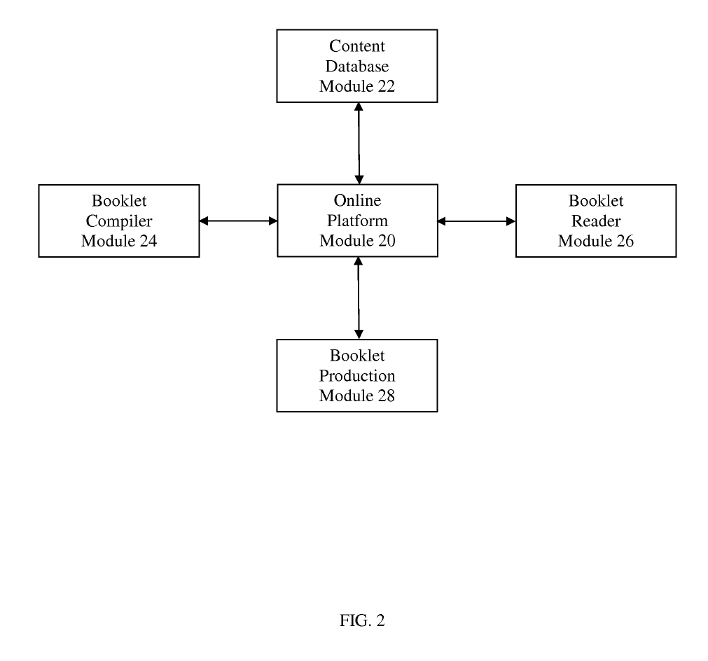

As mentioned earlier, in one aspect the present invention is embodied a computer program product that causes a data processing apparatus to perform the methods of the present invention. The computer program product includes a computer usable non-transitory medium (e.g. memory or storage device) having a computer readable program code embedded therein for controlling a data processing apparatus, where the computer readable program code is configured to cause the data processing apparatus to execute the method of the present invention. The computer readable program code includes many functional modules and the essential ones that are closely related to the steps of the process described below are exemplarily shown in FIG. 2.

Referring to FIG. 2, there is schematically shown an exemplary computer program architecture in which embodiments of the present invention may be implemented. The computer program architecture shown in FIG. 2 includes functional modules that are essential and closely related to the steps of the process according to the present invention.

More specifically, there is shown an online platform module 20 that controls and executes the operations at the server 2 (and/or the print shop server 8) shown in FIG. 1 for providing an online platform to implement the relevant steps of the present invention process, including but not limited to, providing a user interface (UI) to the clients, providing clients account and access management on the server 2, providing folder structure and data storage management to the clients on the server 2, and providing online ordering and payment capacities on the server 2, etc.

There is also shown in FIG. 2 a booklet compiler module 24 that controls and executes the operations at the customer's computer 4 or server 2 (and/or the server at copyright management center 6) shown in FIG. 1 for providing access to server 2 by a compiler, managing the compiler's account information at the server 2, managing the file folders assigned to the compiler, creating and editing booklets, ordering booklets and paying online, etc.

There is further shown in FIG. 2 a booklet reader module 26 that controls and executes the operations at the customer's computer 4 or server 2 (and/or the server at copyright management center 6) shown in FIG. 1 for providing access to server 2 by a reader, managing the reader's account information at the server 2, browsing and searching for booklets, ordering booklets and paying online, etc.

In addition, there is shown in FIG. 2 a booklet production module 28 that controls and executes the operations at the server 2 (and/or the server at print shop 8) shown in FIG. 1 for processing print orders made at the online platform 20, processing payment for purchases of booklets, making print job orders, transmitting electronic files of the booklets to the print shop server 8, and handling production, assembly and delivery of booklets, etc.

It is understood that the exemplary computer program architecture in which embodiments of the present invention may be implemented may include other functional modules not shown in FIG. 2 that facilitates the execution of the steps of the process in accordance with the method of the present invention.

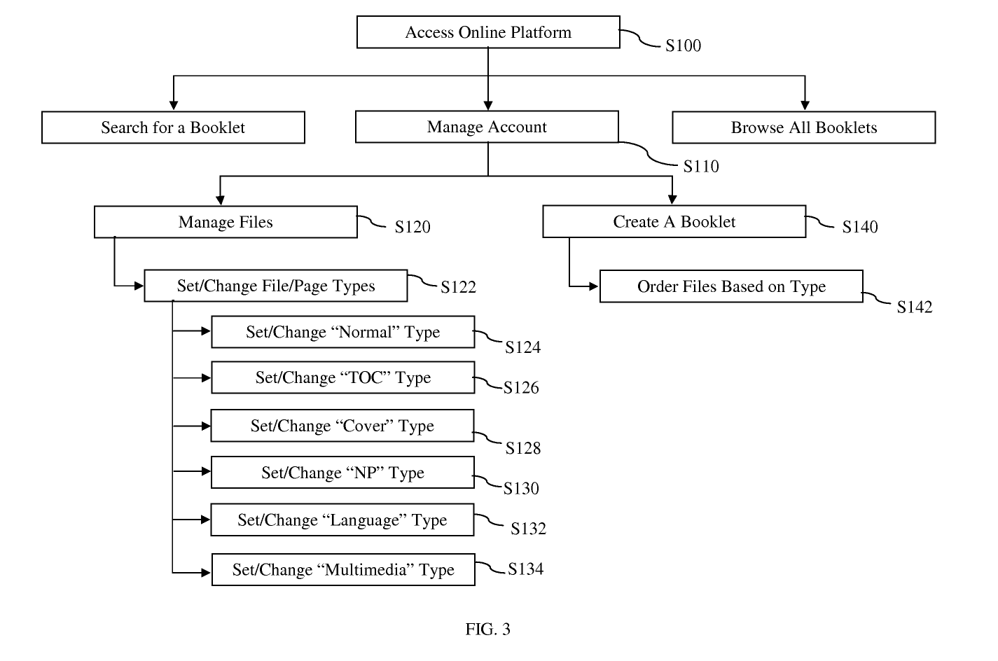

Referring to FIG. 3, there is shown a schematic illustration of an exemplary process for online management of contents and generation of booklets as parts of a computer-implemented method for generating and printing compilations of works in accordance with an embodiment of the present invention. Generally the steps shown in FIG. 3 reflect the steps that a compiler will take to manage the files and create booklets on the server that provides the online platform, e.g., server 2 shown in FIG. 1. Of course anyone who has the access to the server and authority to manage file folders assigned to him or her on the server can take these steps to manage his or her files on the server, not necessarily a complier.

As Step S100 shown in FIG. 3, the compiler accesses the online platform by, e.g., accessing the web-site of the online platform. The compiler typically needs to provide a valid username and a matching password to log in.

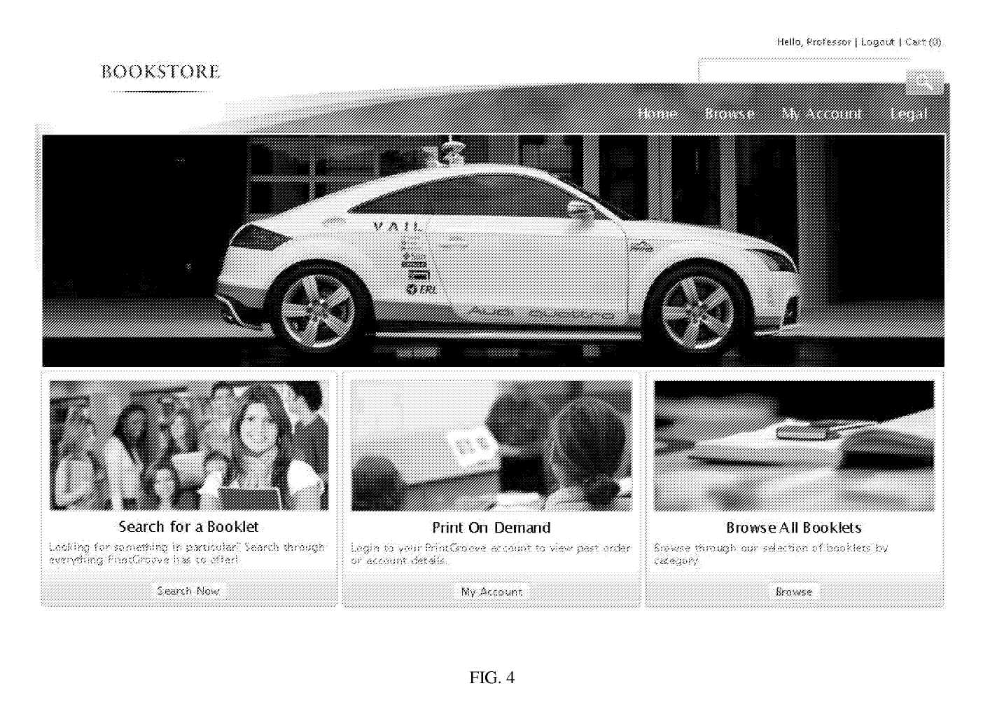

Referring to FIG. 4, there is shown a screen shot of an exemplary user interface (UI) display of the home page of the online platform web-site, in this example an online bookstore, after the compiler logs into the web-site. From this home page the compiler may search for a booklet by clicking on “Search Now” at the lower left portion of the screen, access his or her account by clicking on, e.g., “My Account” at either the top menu bar or the lower middle portion of the screen, or browse all booklets by clicking on, e.g., “Browse” at either the top menu bar or the lower right portion of the screen.

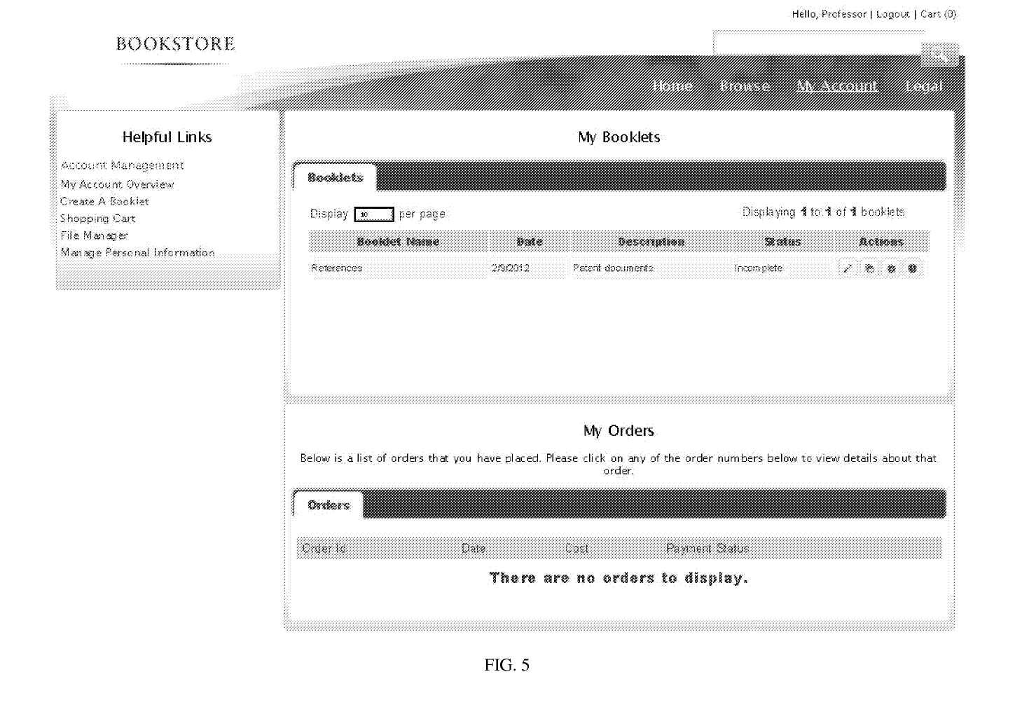

At Step S110 shown in FIG. 3, the compiler access his or her account by clicking on, e.g., “My Account” at either the top menu bar or the lower middle portion of the screen shown in FIG. 4. This will take the compiler to the “Account Overview” page as shown in FIG. 5.

Referring to FIG. 5, there is shown a screen shot of an exemplary UI display of the “Account Overview” page of the online platform web-site. On this page the compiler may see a list of the booklets that have been generated or are in progress, and also the status of all orders placed by the compiler. On the booklet list, each booklet is listed with its name, date of creation, its brief description, and its status. For example, a booklet in progress may be listed as “incomplete” (in progress), “ready” (generated but not activated for ordering), or “active” (activated for ordering). Under the “actions” menu heading at the end of the book list, there are icons for actions that may be taken on each of the booklets. For example, the action icons may include an icon for editing the booklet information, an icon for editing the booklet files, an icon for editing print options, and an icon for activating/deactivating the booklet.

On the left portion of the “Account Overview” page shown in FIG. 5, the compiler may click on the “File Manager” link to manage his or her files, or click on the “Create A Booklet” link to generate a booklet. The compiler may also click on the “Manage Personal Information” link to edit his or her personal information, or click on the “Shopping Cart” link to check out the items he or she intends to order.

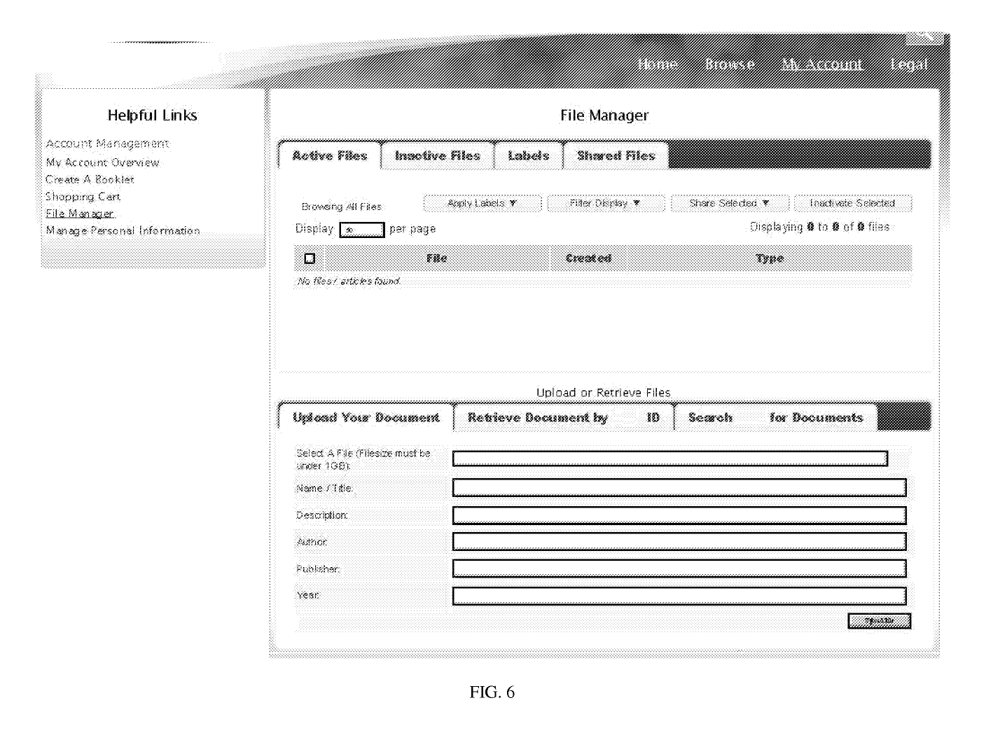

At Step S120 shown in FIG. 3, the compiler performs file management tasks by clicking on the “File Manager” link as shown in FIG. 5. This will take the compiler to the “File Manager” page of the online platform web-site as shown in FIG. 6.

Referring to FIG. 6, there is shown a screen shot of an exemplary UI display of the “File Manager” page of the online platform web-site. On this page the compiler may see a list of his or her files stored on the server, and upload or retrieve files. The main menu bar has buttons that allow the compiler to list “Active Files” that are made active (i.e., can be used in a booklet or shared), “Inactive Files” that remain inactive, “Labels” that are used to label the files, and “Shared Files” that are shared by other colleagues of the compiler.

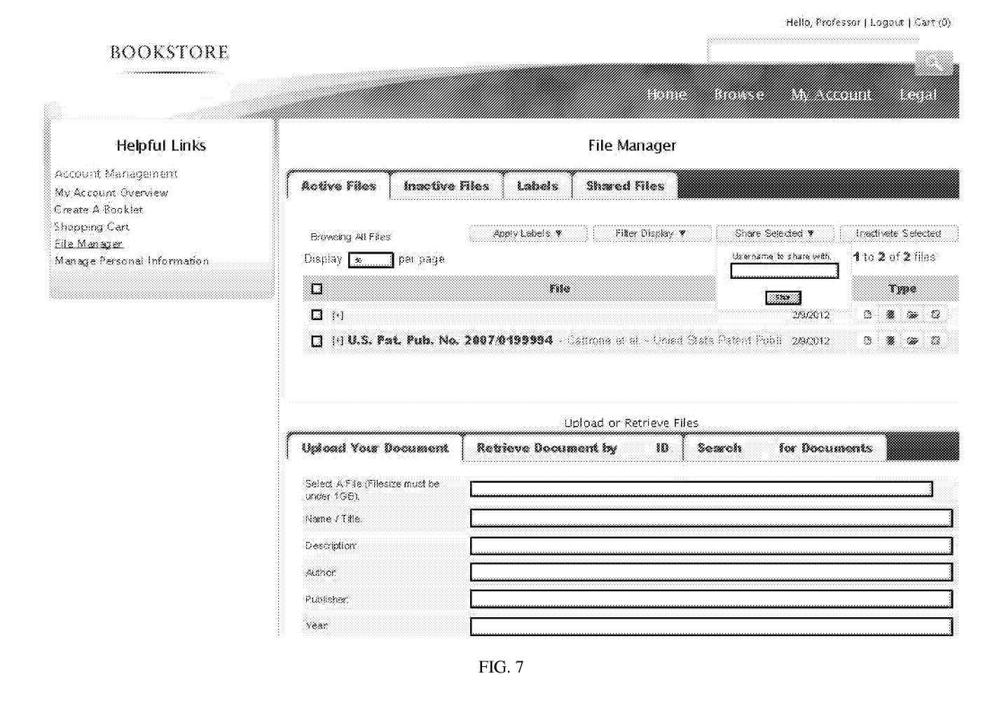

Referring to FIG. 7, there is shown a screen shot of an exemplary UI display of the “Active Files” page of the online platform web-site, upon which the active or activated files are listed. Using the supplemental menu bar under the main menu bar, the compiler may perform various tasks such as applying labels to the files, using filters to display files according to their labels, sharing selected files with the compiler's colleagues, and deactivating selected files, etc.

As shown in FIG. 7, each file may be shown in a one-line view only with its name and the date of creation, or in an expanded view by clicking on a small plus sign icon in front of the file name. In the expanded view the small plus sign icon changes into a small minus sign icon. Clicking on the small minus sign icon will return back to the one-line view.

Particularly, at Step S122 shown in FIG. 3, the compiler may set and/or change file types to each of the active file listed, by clicking on the icons at the end of each file listed under the heading “Type” as shown in FIG. 7.

Referring to FIG. 7, each of the files and/or the pages in each of the files may be designated with a “type” as represented by the small “type” icons. By clicking on a specific one of the small “type” icons, the file/page listed in front of the small icon is designated with or changed into the file/page type represented by that specific icon. This is the “Set/Change File/Page Types” Step S122 shown in FIG. 3.

For example, one of the types that may be designated to a file may be “Normal”, which may be represented by one of the small icons under the heading “Type” as shown in FIG. 7. By clicking on this small icon, the file/page listed in front of icons is designated with or changed into a “Normal” type. Files or pages of a file that are designated as “Normal” type will be treated in a normal manner without special handlings. For example, a PDF file designated as “normal” may be printed as a normal PDF file when a booklet with the PDF file is produced. This is the “Set/Change ‘Normal’ Type” Step S124 shown in FIG. 3.

As another example, one of the types that may be designated to a file may be “Table Of Contents” or “TOC”, which may be represented by one of the small icons under the heading “Type” as shown in FIG. 7. By clicking on this small icon, the file/page listed in front of the icons is designated with or changed into a “TOC” type. Files or pages of a file that are designated as “TOC” type will be treated as a table of contents with special handlings. For example, a table of contents may be automatically generated from and for a document file and saved as a separate TOC file and designated as “TOC” which may be printed on different kind of papers or with special type-settings. This is the “Set/Change ‘TOC’ Type” Step S126 shown in FIG. 3.

As a further example, one of the types that may be designated to a page may be “Cover”, which may be represented by one of the small icons under the heading “Type” as shown in FIG. 7. By clicking on this small icon, the page listed in front of icons is designated with or changed into a “Cover” type. A page that is designated as “Cover” type will be treated as a cover with special handlings. For example, a graphic image may be uploaded and saved as a Cover page and designated as “Cover” which may be printed in color on a heavier grade paper. This is the “Set/Change ‘Cover’ Type” Step S128 shown in FIG. 3.

As yet another example, one of the types that may be designated to a file/pages may be “Non-paginated”, which may be represented by one of the small icons under the heading “Type” as shown in FIG. 7. By clicking on this small icon, the file/pages listed in front of icons can be designated with or changed into a “Non-paginated” type. A file or pages designated as “Non-paginated” type will be treated with special handlings, i.e., when printed or otherwise created as an electronic file, no page number will be used for the file or the pages. This is the “Set/Change ‘NP’ Type” Step S130 shown in FIG. 3.

As still another example, one of the types that may be designated to a file/pages may be “Language”, which may be represented by one of the small icons under the heading “Type” as shown in FIG. 7. By clicking on this small icon, the file/pages listed in front of icons can be designated with or changed into a specific “Language” type. For example, most Western languages documents are printed horizontally from left to right, but certain Asian languages documents are printed vertically from right to left. A file or pages designated as a specific “Language” type will be treated accordingly. This is the “Set/Change ‘Language’ Type” Step S132 shown in FIG. 3.

As still a further example, one of the types that may be designated to a file/pages may be “Multimedia”, which may be represented by one of the small icons under the heading “Type” as shown in FIG. 7. By clicking on this small icon, the file/pages listed in front of icons can be designated with or changed into a “Multimedia” type. For example, a file may be an audio file (e.g. audio book or music file) in a special format (e.g., mp3 format). A file or pages designated as a specific “Multimedia” type will be treated, for example, differently depending on whether the booklet is to be printed as hard copies or distributed electronically, whereas an mp3 file may be omitted from the printed version of the booklet but included in the electronic version of the booklet. This is the “Set/Change ‘Multimedia’ Type” Step S134 shown in FIG. 3.

Of course other types may also be used to designate and handle specific types of files/pages saved in the compiler's file folder for using in compiling a booklet.

A compiler's well managed file folder is in a sense like a small personal “library” of the compiler. The library contains articles with metadata that may be used to retrieve correct intellectual property (IP) rights such as copyrights. Some of the articles in the library may already have associate IP rights, e.g., the articles retrieved from a copyright management center database. Some of the articles on the library may not have IP right yet, e.g., the articles uploaded by the compiler. However, all necessary IP rights will be obtained by the online platform before the articles are used, e.g., printed in a booklet ordered and purchased by the readers. The files in the library are not necessarily purchased yet so they may not be downloaded or otherwise distributed, but the compiler can preview them in order to create booklets, and the IP rights of the booklets will be paid for later when the booklets are purchased.

Some of the articles in the library may have pricing information as well. The price of an article may be based on a number of factors, e.g. the number of pages, membership or affiliation of the compiler and/or the readers, etc. The metadata and other information of the articles may be sent to the copyright management center for calculating the price of the articles.

The “type” used to designate a file or pages in a booklet may be useful to supplement the metadata or information associated with a file. For example, a TOC file generated from and for an original document file designated as the “TOC” type may not need a separate IP right or permission in addition to the original document file and therefore may not require an additional royalty or fee for its inclusion in a compilation booklet. This may further facilitate and expedite the process of verifying or clearing the IP right or pricing information for generating the compilation booklet.

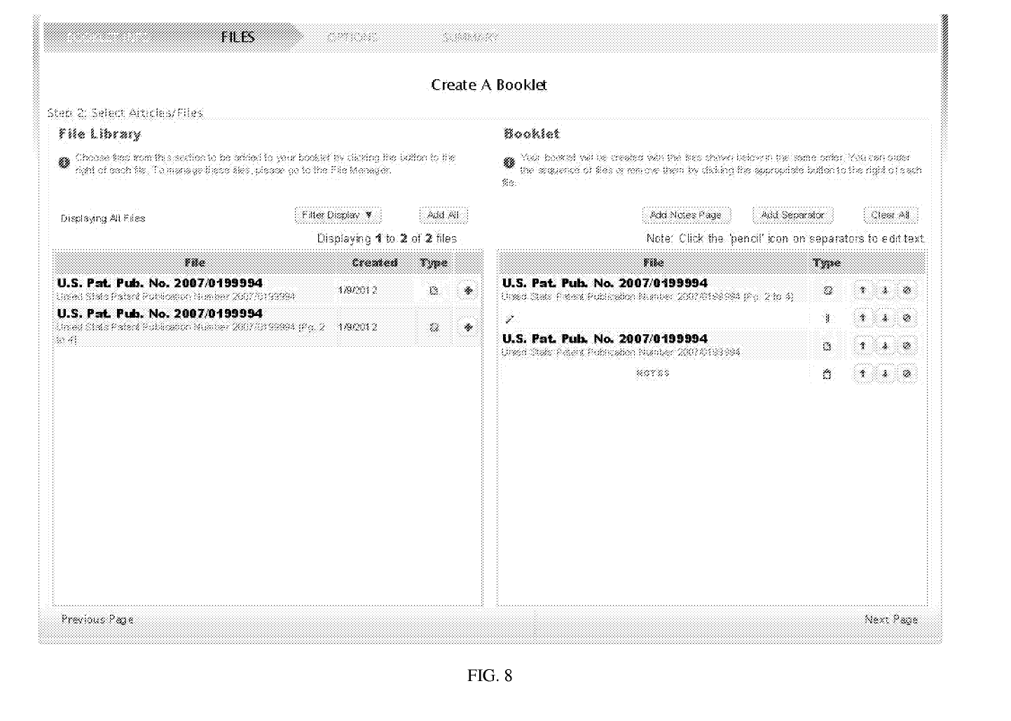

Referring to FIG. 8, there is shown an exemplary user interface (UI) display of the “Create A Booklet” functions for the compiler at Step 140 shown in FIG. 3 to create a booklet.

As shown in FIG. 18, active articles that may be used in the booklet are displayed on the left side portion of the page. The file type of each article is displayed by a small icon under the “Type” heading. This provides a quick reference to the compiler as to the type of each file listed.

In addition to the content files added to the booklet, the compiler may add notes pages to the booklet by clicking on the “Add Notes Page” button, and may also add separator pages to the booklet by clicking on the “Add Separator” button. Notes pages are blank pages for the readers to write their notes on, and separator pages are pages used for separating various parts, sections or chapters of the booklet. The designations of “Note” and “Separator” may be used as additional file/page types.

For all files added into the booklet, including the notes and separator pages, their respective file types are displayed by the small file type icons under the “Type” heading. This provides a quick reference to the compiler as the type of each file, e.g., a normal article, a cover image, a table of contents (TOC), a non-paginated excerpt, a special language page, a multimedia page, a notes page, a separator page, etc. The display of the file type may help the compiler in compiling the booklet. For example, the display of the file type may assist the compiler to quickly determine the appropriate order of the files in the booklet, which may be adjusted by clicking on the moving up or moving down icons at the end of the file name. In other words, the specific type designation to the file/pages may be used for ordering of the files in the booklet. For example, a cover page may be placed at the beginning of the booklet, while a notes page may be placed at the end of the booklet. This is the “Order Files Based on Type” Step S142 shown in FIG. 3. Of course, as mentioned before, the types designated to the files/pages may also be used in the subsequent special treatment and handling of the files/pages when producing and/or delivering the booklet.

The above described process may be implemented by a computer software program. The present invention also provides a computer program product that includes a computer usable non-transitory medium (e.g. memory or storage device) having a computer readable program code embedded therein for controlling a data processing apparatus, the computer readable program code configured to cause the data processing apparatus to execute the above described process.

It will be apparent to those skilled in the art that various modification and variations can be made in the method and related apparatus of the present invention without departing from the spirit or scope of the invention. Thus, it is intended that the present invention cover modifications and variations that come within the scope of the appended claims and their equivalents.

What is claimed is:

1. A method for managing files for producing a compilation of works, comprising the steps of:
obtaining a file of a work to be compiled in the compilation of works;
specifying at least one type designation to the file or a portion thereof; and
rendering special treatment of the file or the portion thereof according to the at least one type designated to the file or the portion thereof when producing the compilation of works.

2. The method of claim 1, wherein the at least one type designation is “table of contents”.

3. The method of claim 1, wherein the at least one type designation is “cover”.

4. The method of claim 1, wherein the at least one type designation is “non-paginated”.

5. The method of claim 1, wherein the at least one type designation is “language”.

6. The method of claim 1, wherein the at least one type designation is “multimedia”.

7. The method of claim 1, further comprising the step of modifying the at least one type designated to the file or the portion thereof.

8. The method of claim 1, further comprising the step of displaying the at least one type designated to the file or the portion thereof in a user interface for managing the files for producing the compilation of works.

9. The method of claim 1, further comprising the step of displaying the at least one type designated to the file or the portion thereof in a user interface for generating the compilation of works.

10. The method of claim 1, further comprising the step of ordering the files for producing the compilation of works based on the at least one type designated to the file or the portion thereof.

11. A computer program product comprising a non-transitory computer usable medium having a computer readable code embodied therein for controlling a data processing apparatus, the computer readable program code configured to cause the data processing apparatus to execute a process for managing files for producing a compilation of works, the process comprising the steps of:
obtaining a file of a work to be compiled in the compilation of works;
specifying at least one type designation to the file or a portion thereof; and
rendering special treatment of the file or the portion thereof according to the at least one type designated to the file or the portion thereof when producing the compilation of works.

12. The computer program product of claim 11, wherein the at least one type designation is “table of contents”.

13. The computer program product of claim 11, wherein the at least one type designation is “cover”.

14. The computer program product of claim 11, wherein the at least one type designation is “non-paginated”.

15. The computer program product of claim 11, wherein the at least one type designation is “language”.

16. The computer program product of claim 11, wherein the at least one type designation is “multimedia”.

17. The computer program product of claim 11, wherein the process further comprises the step of modifying the at least one type designated to the file or the portion thereof.

18. The computer program product of claim 11, wherein the process further comprises the step of displaying the at least one type designated to the file or the portion thereof in a user interface for managing the files for producing the compilation of works.

19. The computer program product of claim 11, wherein the process further comprises the step of displaying the at least one type designated to the file or the portion thereof in a user interface for generating the compilation of works.

20. The computer program product of claim 11, wherein the process further comprises the step of ordering the files for producing the compilation of works based on the at least one type designated to the file or the portion thereof.
